(19) United States
(12) Patent Application Publication
(10) Pub. No.: US 2026/0283121 A1
(43) Pub. Date: Sep. 24, 2026

(54) A BIODEGRADABLE SUBSTRATE FOR GROWTH ACCOMMODATION OF OYSTERS AND/OR OYSTER LARVAE

(71) Applicant: Oyster Heaven IP B.V., Rotterdam (NL)

(72) Inventor: George BIRCH, Rotterdam (NL)

(73) Assignee: Oyster Heaven IP B.V., Rotterdam (NL)

(21) Appl. No.: 18/996,117

(22) PCT Filed: Jul. 24, 2023
(86) PCT No.: PCT/NL2023/050395

§ 371 Date: Jan. 17, 2025

(30) Foreign Application Priority Data
Jul. 29, 2022 (NL) 2032634

(51) Int. Cl. A01K 61/54; A01K 61/77

(52) U.S. Cl. CPC A01K 61/54; A01K 61/77

(57) ABSTRACT

The invention relates to a biodegradable substrate for growth accommodation of oysters and/or oyster larvae, comprising an extruded block, comprising a clay material; at least one hollow, at least partially surrounded by the extruded block, extending in the extrusion direction of the block; wherein at least one surface of the extruded block comprises a wavy or undulating pattern; wherein the block comprises a porous structure.

The present invention relates to a biodegradable substrate for growth accommodation of oysters and/or oyster larvae and to a method for manufacturing a biodegradable substrate.

Over the years, the vast majority of oysters from the oceans have been consumed, almost to extinction. The numbers of oysters gone are 95% in the North Sea and 85% worldwide. Oysters used to have an incredible impact on the marine environment and perform critical ecosystem functions, therefore the loss of our oyster reefs represents an enormous loss to society since a healthy ocean is a key to climate change. They improve biodiversity, reduce algal blooms and eutrophication, store carbon, stabilise our shores and prevent tidal surges. A single oyster can filter up to 200 litres of water a day; removing pollutants including sewage waste, nitrogen, phosphate, and even microplastics.

Ways to farm oysters on artificial substrates have also been known for a long period of time. These substrates are typically formed of concrete or granite or limestone or plastic, and they have a long-lasting negative effect on the marine environment and the climate. These known substrates available in the art are furthermore not cost-effective, more difficult to manufacture, and some require specialised production and/or deployment projects, which are not necessarily scalable. Currently available substrates are also relatively unattractive to oyster larvae, consequently leading to slower regeneration of oysters.

The goal of the present invention is to overcome these disadvantages and provide a biodegradable, sustainable, more cost-effective, and scalable alternative to accommodate the faster regeneration and growth of oysters by using all-natural and easily accessible materials. Furthermore, it is also aimed to increase biodiversity as the invention may also host other surrounding marine creatures once it is deployed into the water. Water may refer to a body of liquid that may include, but is not limited to, at least a portion of brackish water or seawater or water with any degree of salinity.

To that end, the invention proposed a substrate, in particular, a decomposable and/or biodegradable substrate according to claim 1, in particular, “Mother Reef”, a biodegradable and climate-positive substrate for growth accommodation of oysters and/or oyster larvae, comprising at least one block, preferably an extruded block, comprising at least one ceramic material, such as clay; at least one hollow, preferably formed as a through-hole, at least partially surrounded by the extruded block, extending in the extrusion direction of the block preferably over the entire length of the extruded block; wherein at least part of the surface, preferably an inner surface of at least one hollow and/or an outer surface of the extruded block comprises a wavy and/or undulating pattern; wherein at least part of the extruded block comprises a porous structure.

The substrate according to the invention is decomposable and/or (bio)degradable and thus may degrade over time. This invention introduces the utilization of a ceramic material, such as clay, as a decomposable and/or biodegradable core material of the block. Advantageously, clay material is low-cost, (bio)degradable, uncomplicated to manufacture especially on a large scale for example by extrusion, and adaptable to the local area as clay is ubiquitous all around the world. It is also possible for marine organisms to drill on the clay, unlike granite or concrete, thus other marine creatures and microorganisms may penetrate and use the block as a shelter, which then over time will increase biodiversity and better thriving marine ecosystems. Preferably, the substrate is made of a local clay. Therefore, the production method and the final characteristics of the substrate can vary depending on the characteristics of the applied (local) clay. The block may comprise a shape of, but is not limited to, trapezoidal-prism clay with a substantially porous structure. The substrate according to the invention further benefits from the fact that after its use and decomposition, there will be no remains in the sea found that would not already be found there (i.e. the mud and sand) which is positive from the environmental point of view.

When it is referred to a hollow, also a cavity, receiving space, void, and/or channel could be meant or referred to. The at least one hollow is preferably formed as a through-hole, preferably made by extrusion from one side all the way to the opposite side of the extruded block. The length direction of at least one hollow, and preferably each hollow, extends in the direction of extrusion. At least one hollow is preferably arranged at a distance from a lower side and/or an upper side of the block. It is also possible that at least one hollow is located on the lower side and/or the upper side of the block. This way, there are more surfaces for the oysters to attach to.

At least part of the surface of the extruded block, preferably an inner surface of at least one hollow, and preferably each hollow and/or an outer surface of the extruded block comprises a wavy and/or undulating pattern. It is for example imaginable that at least 50% of the outer surface of the extruded block comprises a wavy and/or undulating pattern, preferably at least 80% and more preferably at least 90%. It is also imaginable that at least 50% of the inner surface of at least one hollow comprises a wavy and/or undulating pattern, preferably at least 80% and more preferably at least 90%. These embodiments will positively contribute to the flow of water surrounding it. The wavy and/or undulating pattern will have a positive effect on the water flow such that a comfortable environment of the oysters and/or oyster larvae is created. The wavy and/or undulating pattern will in particular cause flow low areas, which preferably have laminar flow.

At least one hollow, and preferably each hollow, is defined by a wall part. It is imaginable that the ratio of the thickness of the wall part and the height of the hollow is at least 1:2, preferably at least 1:3, more preferably at least 1:5. The wall parts are preferably designed such that degradation of the block is facilitated in an effective way. Due to the combination of the shape of the block, and the surface structure thereof, the created flow pattern of water surrounding the block will also effectively contribute to the degradation process and/or enhances the fracturing and/or collapsing of the block. It is for example imaginable that the wall thickness of at least one wall part is at least 1.5 centimetres, preferably in the range of 1.5 to 5 centimetres, more preferably in the range of 2 to 3 centimetres. In a preferred embodiment, a height or a diameter of at least one hollow is at least 8 centimetres, centimetres, preferably at least 4.5 centimetres, or preferably at least 2.5 centimetres. The height of the hollow is typically defined by a furthest distance between its two opposite sides, for instance, the first and the second sides of the hollow. The diameter is substantially equal to a height and/or width of a quadrilateral or trapezoid shape. At least one hollow is preferably configured such that at least one adult oyster can be accommodated inside said hollow. Preferably, the at least one hollow could make up of at least 20% volume of the block, more preferably at least 30% volume of the block. The perimeter of the at least one hollow is preferably at least 10 centimetres, more preferably at least 15 centimetres, even more preferably at least 20 centimetres. The hollow(s) in the block increases the available surface area for oysters to attach to, where the undulating surface mimics the shape of natural oyster shells. Despite the substrate being configured for the growth accommodation of oysters and/or oyster larvae, the substrates according to the invention could be used for any sessile marine organism that requires a hard surface to settle on, such as but not limited to mussels, clams, seaweed, etc. In a preferred embodiment, the extruded block may comprise at least two, preferably three quadrilateral-shaped, such as trapezium-shaped hollows preferably with a wavy and/or undulated patterned surface preferably realised by means of extrusion. The block may comprise at least two hollows formed as through-holes, preferably at least three hollows formed as through-holes, at a distance from each other, wherein said distance is in a direction perpendicular to the extrusion direction of the block. The at least two hollows may have a similar shape or a mirrored shape to each other. It is possible that one hollow is smaller than at least another hollow. The shape might comprise other non-limitative geometrical shapes such as a circle, triangle, pentagon, hexagon, octagon, or the like.

In one embodiment, the perimeter of the outer surface of the block is at least 35 centimetres, more preferably at least 45 centimetres, and even more preferably at least 55 centimetres. Preferably, a second side of the extruded block is wider compared to a first side of the extruded block, wherein the first and the second sides are located at the opposite of each other, and optionally wherein a third side and a fourth side are located at the opposite of each other. In one embodiment, the second side or a base width of the extruded block may be wider than the first side or a top width. The at least a part of the top width may shape at least slightly concavely or at least slightly recessed. The at least slightly recessed shape can be beneficial for the stacking of the block, such that it ensures sufficient space between the stacking blocks whereby the oysters and/or oyster spats can flourish and are not ground off by the stacking blocks, for example, during transport or after deployment in the water. In another preferred embodiment, the extruded block may comprise a more protruding area on one shorter edge and one opposite of the said shorter edge of the top width or side of the block, while the top side is substantially planar. The shape of the at least a part of the top side of this embodiment can also be understood as a substantially recessed shape, for example, a curved shape or a U-shape. Such shapes may be aimed to easily facilitate the transportation or pick up of the blocks and an increased surface area for the growth of the oysters, and other possible marine life. Moreover, the shape can also facilitate that the oysters and/or oyster spats are not ground off by the stacking blocks. Such shapes may also be aimed to be easily producible by any generic brick factory or manufacturer, and able to be clamped in different situations, preferably in four different configurations. The clamp may comprise at least a straight wall substantial enough for the clamp to hold the blocks. The extrusion method is preferably chosen as means of production because it may lead to a more scalable production; be easier than other methods, such as casting; and be suitable for the materials used for producing the blocks. It is likewise relatively more efficient and economical for generic brick manufacturers to produce a mass scale of these blocks. The geometry of the substrates according to the present invention benefits from the fact that, when placed closely together or stacked in oyster tanks, openings are created between the surfaces that allow larvae to settle on the surface of the substrate.

The wavy and/or undulating pattern may comprise a plurality of parallel grooves, extending in the same direction as the extrusion direction of the block. These grooves may vary along the outer circumference of the block and mimic the shape of natural oyster shells. These grooves preferably resemble sine or sinusoidal waves, in particular such that it ensures the ribbing effect that mimics the natural form of oyster ribs which are also sine waves. These grooves, formed during the extrusion of the block, may provide a natural habitat for the oysters to attach to, as the oysters have a rather similar wavy pattern on the top surface of the shell. A hard and attractive surface to grow on is all oysters need to start providing their multiple benefits because one of the problems with oyster regeneration is that there is not enough hard surface to settle, for example, in the North Sea, there is mainly sand. The hard, wavy pattern therefore also increases the surface area, which may induce more oysters and/or oyster larvae to settle. Said unique pattern of the block may be aimed to be relevant for the flow pattern of water surrounding the block, preferably low flow areas and the like, in order to create a comfortable environment for the oysters and/or oyster larvae to settle and/or grow. Typically, the wavy and/or undulating pattern diminishes in size as they reach the centre of the block, which also matches what occurs on oyster shells naturally. The wavy and/or undulating pattern is preferably applied on the inner surface of at least one hollow and the outer surface of the extruded block. In a further preferred embodiment, substantially all surfaces of the extruded block comprise a wavy an/or undulating pattern. That could also include the surfaces surrounding the hollow(s), or thus the inner surface defining the hollow(s). This way, more increased surface area can be achieved to induce more oysters to settle. The wavy and/or undulating pattern on at least one surface may comprise at least one peak and one valley. This way can also ensure the ribbing effect that mimics the natural form of oyster shells.

The substrate according to the present invention may comprise at least one biofilm preferably comprising natural compounds. The wavy-patterned surface may also be treated with a biofilm comprising natural compounds which preferably produce chemical signals for oysters that want to settle before being deployed into the water, preferably in locations of expansion of the artificial and/or natural reefs. Other healthy oyster larvae can ‘smell’ the biochemical signals produced by certain symbiotic microorganisms from the applied biofilm. The application of biofilm may increase the effectiveness of oyster and/or oyster larvae attachments, and increase the time window of regeneration projects. The biofilm on the “Mother Reef” block may be applied onshore, preferably by a spraying or soaking method, and the production of said natural biofilm is specialised in a specific culture procedure. In another preferred embodiment, the block may be pre-charged with oyster larvae, wherein the larvae may settle onto the block in settlement tanks onshore before being deployed into the water, preferably in locations where oysters are extinct and there were historic reefs but no healthy populations remaining. When the pre-charged oyster spats reach at least a few weeks old, they are ready to be deployed into the water. At around this moment, the oyster spats are considered robust enough to resist certain types of predation. In another embodiment, it is viable to have both the biofilm applied on the blocks and the settlement of oyster larvae before deployment into the water. The invention thereto proposes a “Mother Reef” block with a wavy surface mimicking the structure of the oyster shells which may increase attractiveness and quantity for the oysters and/or oyster larvae.

The “Mother Reef” block comprises a porous structure, for instance, by adding a combustible material, like paper, being burnt completely during the production method. Combustible material, such as paper, may be incorporated into the ceramic material, for example the clay mixture in appropriate proportions and will be burnt during the combustion process to form a porous structure. The porous structure, additionally together with the sharp notches shape on its surface, may facilitate the collapse of the block when internal pressure is built up as a result of oyster growth. The porous structure increases the brittleness of the extruded block and such block may accommodate the settlement of oysters and/or oyster larvae before eroding in the water and disintegrating naturally into small clay particles. In case multiple blocks are dropped in the water, a certain amount of purposeful fracturing is expected of these blocks due to their shape and porosity. These fractures lead to further complexity of the piles of these blocks and fractions thereof, which closely mimic random undulations of marine life rather than artificial and simple geometry alternatives. Depending on the factors, such as the environmental influence and the materials applies, the substrates could last for between 2 to 500 years from their deployment into the water depending on the local permitting requirements. Typically, the substrate lasts at least 10 years, preferably after 25 years from its deployment into the water. The block fractures easier, when it comprises the porous structure, by means of natural pressure from the attached oysters, thereafter making it (bio)degradable and sustainable as the clay itself is a natural material. On top of being naturally friendly, the cost of producing each block is considered low and deployment is easily performed cost-efficiently. Preferably the complete outer and inner surface of the block has a porous structure.

Correspondingly, the preferred weight of “Mother Reef” block may be less than 20 kilograms, preferably less than 16 kilograms, more preferably less than 14 kilograms. It is also conceivable that the decomposable and/or biodegradable substrate, and in particular the block, weighs between 6 and 10 kilograms. This results in the blocks being relatively easy to handle. It is also conceivable that the substrate according to the present invention has a weight above 5 kilograms, preferably above 7 kilograms. The density of the block may be between 1 and 4 kg/m³, preferably between 1.5 and 2.5 kg/m³, more preferably around 2 kg/m³. The height of the block may be between 10-20 cm, more preferably about 15 cm. However, it is also imaginable that the width of the block may be between 25-35 cm, more preferably about 30 cm. This configuration may lead to easy access and deployment by communities in smart locations, including by fishermen. Some preferred embodiments of the block may be applicable to around 20×30×15 cm in size and around 8-8.5 kg in weight. Thus, deployment of each block into the water is easily attainable from a boat, for example, a fishing boat.

Nowadays, the placement and deployment practices are problematic as working in the high seas is dangerous, expensive, and very prescriptive, meaning that projects are smaller and less resilient. These projects also provide low added value to society as fishermen are excluded and benefits are focused far from populated areas. The inventors also propose critical mass projects in smart locations, with a minimum of 3.75 million oyster projects placed in coastal and estuarine areas. Critical mass is a concept that defines the theoretical number and density of oysters required to generate population survival. A lower line of critical mass equals a lower cost to achieve ecosystem take-off. High seas around wind farms almost always have a higher critical mass than coastal estuarine areas. This concept may be supported by a mapping protocol looking at marine conditions including temperature, pH, nutrient concentrations, salinity, and water currents to help spot the best locations for placing the “Mother Reef” blocks. Therefore, coastal communities, such as fishermen, will also have a new critical stewardship role by using their knowledge and love of water, slack time from quota-restricted days, and pre-existing hardware such as their vessels, sonar, and radar, by involving them in the deployment of the “Mother Reef” project.

The invention additionally relates to a method of manufacturing a decomposable and/or biodegradable substrate, in particular according to the invention, comprising the steps of:
a) mixing at least one ceramic material and/or optionally a combustible material into a malleable core material;
b) extruding the core material into an extruded block and forming at least one through-hole in the extruded block in the extrusion direction, wherein during extrusion, at least part of the surface of the extruded block is provided with a wavy and/or undulating pattern;
c) drying or solidifying the extruded block; and
d) baking the extruded block thereby burning at least part of the ceramic material and/or the combustible material of the extruded block such that a porous structure is obtained.

The method according to the present invention is in particular configured to produce a substrate according to the present invention. At least part of the surface of the extruded block is provided with a wavy and/or undulating pattern during the extrusion process. At least one hollow, or cavity, is formed during the extrusion step. Preferably, the mouthpiece of the extruder is configured to create the specific configuration. The method according to the invention could be applied to manufacture any of the embodiments as described for the present invention.

Step d) could also be described as, subjecting the block to a firing step such that at least part of the ceramic material and/or combustible material is burned and possibly such that the ceramic material of the block is at least partially cured and such that a substantially porous structure is obtained. The baking step of the method is preferably done at a relatively low firing temperature and/or for a relatively short baking time. The temperature may depend on the type of ceramic material, for example a clay, the sediment load, and/or the water speed. This results in the desired material properties of the substrate and this is also beneficial from an environmental point. In one preferred embodiment, the temperature for baking may be less than 1050 degrees Celsius. More preferably, the temperature for baking the block is at most 1000 degrees Celsius. Even more preferably, the temperature for baking ranges from 500 to 1000 degrees Celsius. A lower temperature for baking may be advantageous for the erosion process of the block. A degree of erosion occurs because of the level of sintering that happens in the block. Sintering can provide mechanical strength, eliminates pores, and increases ceramic density. At lower temperatures, incomplete sintering may occur. Consequently, the substrate will slowly erode in the water more easily. At higher temperatures, more complete sintering can happen, therefore erosion happens much slower. It is another advantage of the block that at least a part of the material of the substrate is preferably sintered incompletely, such that it is easier to naturally degrade. Preferably, all parts of the substrate may be sintered incompletely. Therefore, the block is more sustainable and biodegradable as the block will become mud and sand again once it is eroded, preferably fully eroded. The baking process is preferably done such that substantially all combustible material is burned. It is conceivable that the baking process is done such that the ceramic material is only partially hardened or cured. In one preferred embodiment of the method according to the invention, a preferred action may be performed, further comprising step e) cutting the block in a plurality of bricks or substrates. In another preferred embodiment, another preferred action may be performed, further comprising step f) applying a biofilm to the block and/or pre-charging the block with oyster larvae before deployment. Step c) of the method could for example include that the block is cooled down by sun-drying, firing, and/or oven-drying.

The invention is further elucidated on the basis of the non-limitative exemplary embodiment shown in the following figures. Herein:

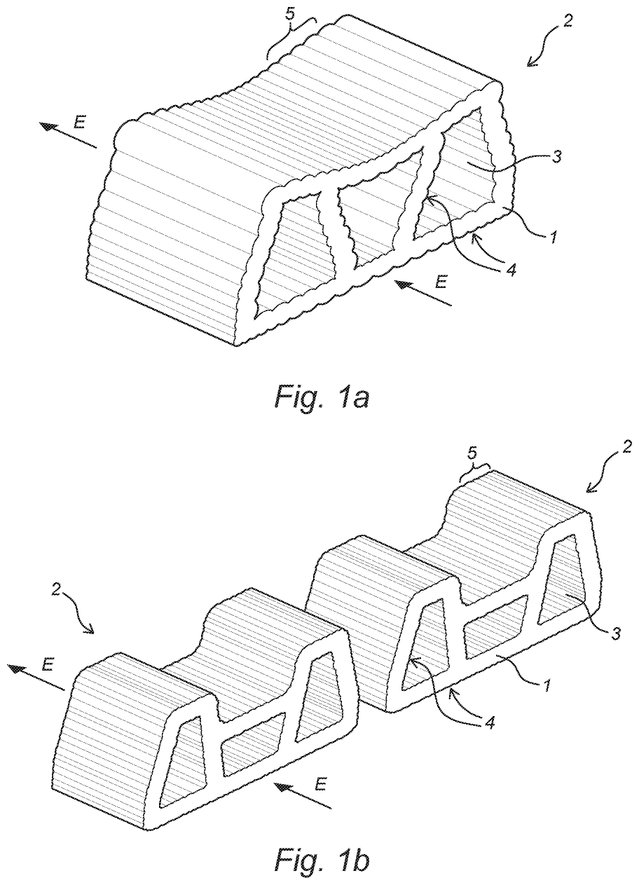

FIGS. 1a and 1b schematically show possible embodiments of substrates according to the invention;

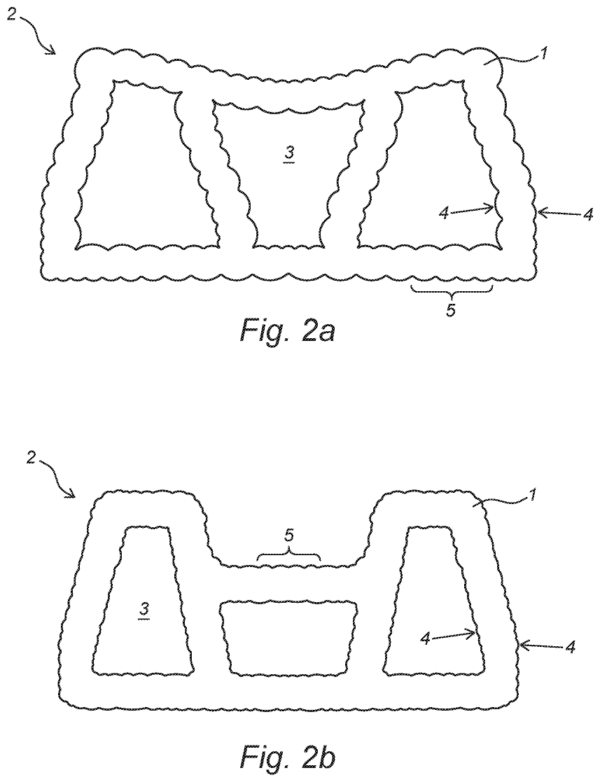

FIGS. 2a and 2b show a cross-sectional view of the substrates as shown in FIGS. 1a and 1b;

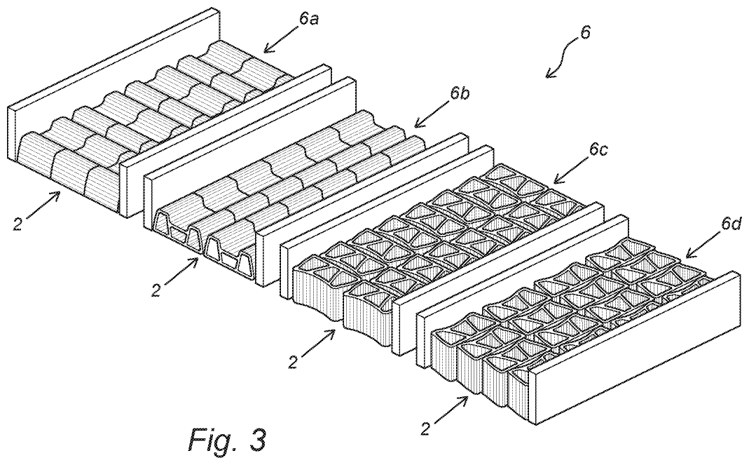

FIG. 3 schematically shows an example of four different possible configurations of the plurality of the blocks being clamped together according to the present invention;

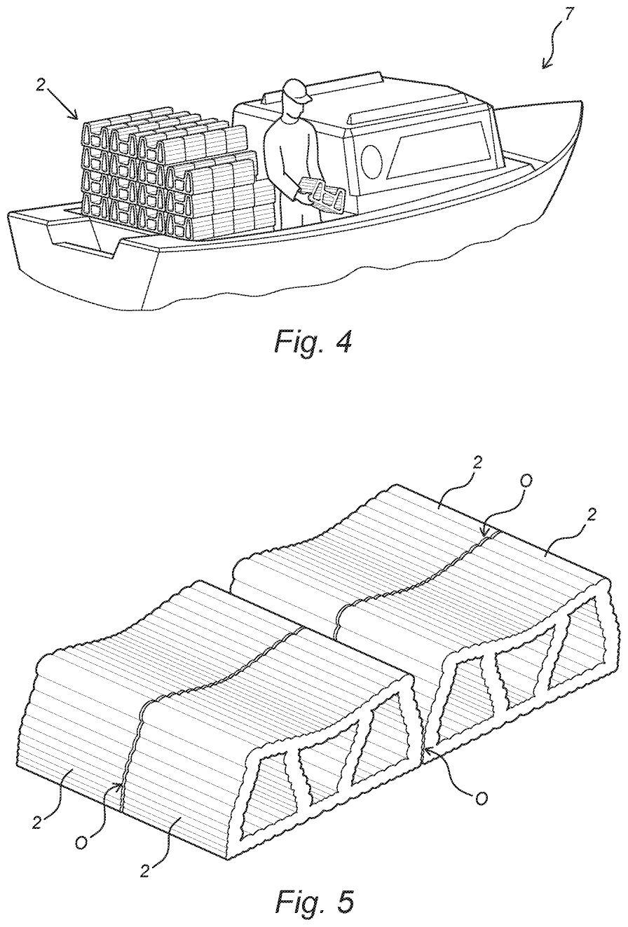

FIG. 4 schematically shows an example of the deployment project from a boat according to the present invention; and

FIG. 5 shows a plurality of substrates as shown in FIGS. 1a and 2a in a stacked configuration.

Within these figures, similar references refer to similar or equivalent features or elements.

FIGS. 1a, 1b, 2a, and 2b schematically shows a substrate (1) according to the invention. FIGS. 1a and 1b show a perspective view of respectively a first and a second embodiment of the substrate (1) according to the present invention, while FIGS. 2a and 2b show a side view of said first and second embodiment. The substrate (1) comprises an extruded block (2), comprising a clay material and at least one hollow (3), at least partially surrounded by the extruded substrate (1), extending over the entire length of the block (2) in the extrusion direction (E) of the block (2) such that a through-hole (3) is formed. The surface (4) of the extrude block (2), including the surface of the at least one hollow formed as a through-hole (3), comprises a wavy or undulating pattern (5). The wavy and/or undulating pattern (5) preferably mimics physical substrates of oyster shells which have different sizes of wavy patterns, as the wavy patterns may comprise smaller waves and bigger waves. The grooves of wavy and/or undulating patterns (5) are resembling sine waves that is mimicking the natural form of the oyster. Typically, the wavelength of the waves on the surface of the substrates (1) is diminishing gradually similar to the oyster shells themselves. The combination of different sizes preferably may accommodate oysters having different heights and widths to settle or attach in block (2). Block (2) has a porous structure created by burning the combustible material, such as, but not limited to, paper, during the production process. The porous structure of said substrate (1) may accommodate the block to fracture with the help of natural pressure from the attached oysters and eventually may disintegrate into at least a portion of mud and/or sand, preferably being up to 100% decomposable and/or biodegradable and leaving no waste in the sea.

FIG. 2a is a schematic cross-section view of one embodiment of the block (2). The bottom width is larger than a top width, while the top width shown in this embodiment is slightly concaved. This slight concave accommodates the space between stacking of the blocks (2) such that there is enough space for the settled oyster and/or oyster larvae, and such that the oyster and/or oyster larvae are not ground off during transport or after deployment. FIG. 2b is another example of a schematic cross-section view of one exemplary embodiment wherein the block (2) comprises the top side with a substantially deeper recessed area, comparable to a U-shape or a deeper concave. These non-limiting shapes are also beneficial for more efficient stacking for transport and handling.

FIG. 3 schematically shows an example of four different possible configurations (6a, 6b, 6c, and 6d) of the plurality of the substrates (2) or blocks (2) according to the present invention being clamped together. It is conceivable that the unique and practical shape of the block (2) may be handled in large volumes, therefore increasing producibility and scalability.

FIG. 4 schematically shows an example of the deployment project from a boat (7) according to the present invention. It is conceivable that the deployment project is easily attainable by at least one person from a boat. It is shown that blocks (2) are released into the water. The block (2) that is applied with biofilm and/or pre-charged oyster larvae and/or spats is able to be deployed by the person using a normal boat or fishing vessel.

FIG. 5 shows a plurality of substrates (2) or blocks (2) as shown in FIGS. 1a and 2a in a stacked configuration. It is for example conceivable that such stacking in applied in an oyster tank (not shown). It can be seen that the geometry of the blocks (2) creates openings O between the surfaces that allow larvae to settle on the surface of the substrates.

It will be clear that the invention is not limited to the exemplary embodiments which are illustrated and described here, but that countless variants are possible within the framework of the attached claims, which will be obvious to the person skilled in the art. In this case, it is conceivable for different inventive concepts and/or technical measures of the above-described variant embodiments to be completely or partly combined without departing from the inventive idea described in the attached claims.

The verb ‘comprise’ and its conjugations as used in this patent document are understood to mean not only ‘comprise’, but to also include the expressions ‘contain’, ‘substantially contain’, ‘formed by’ and conjugations thereof.

1. A biodegradable substrate for growth accommodation of oysters and/or oyster larvae, comprising:
an extruded block, comprising a ceramic material;
at least one hollow formed as a through-hole, at least partially surrounded by the extruded block, extending in the extrusion direction of the extruded block;
wherein at least part of an inner surface of at least one hollow and at least part of an outer surface of the extruded block comprises a wavy and/or undulating pattern; and
wherein at least part of the extruded block comprises a porous structure.

2. The substrate according to claim 1, wherein the wavy and/or undulating pattern comprises a plurality of parallel grooves, extending in the same direction as the extrusion direction of the extruded block.

3. The substrate according to claim 1, wherein at least part of the extruded block is substantially trapezoidal-prism shaped, wherein preferably a second side of the extruded block is wider compared to a first side of the extruded block, wherein the first and the second sides are located at the opposite of each other.

4. The substrate according to claim 1, wherein at least part of at least one hollow is quadrilateral-shaped or trapezium-shaped.

5. The substrate according to claim 1, comprising at least two hollows or at least three hollows, wherein each hollow is formed as a through hole and wherein the hollows are positioned at a distance from each other in a direction perpendicular to the extrusion direction of the extruded block.

6. The substrate according to claim 1, wherein at least 50% of the outer surface of the extruded block comprises a wavy and/or undulating pattern and/or wherein at least 50% of the inner surface of at least one hollow comprises a wavy and/or undulating pattern.

7. The substrate according to claim 1, wherein the substrate weighs less than 20 kilograms and wherein the density of the extruded block is between 1 and 4 kg/m3.

8. (canceled)

9. The substrate according to claim 1, wherein the height of at least part of the substrate is between 10 and 20 cm and/or wherein the width of the substrate is between 25 and 35 cm.

10. The substrate according to claim 1, further comprising at least one biofilm, said biofilm preferably comprising natural compounds.

11. The substrate according to claim 10, wherein at least 50% of the inner surface of at least one hollow and/or at least 50% of the outer surface of the extruded block is covered with at least one biofilm.

12. The substrate according to claim 1, wherein at least one wavy and/or undulating pattern varies along the outer circumference of the extruded block and/or wherein at least one wavy and/or undulating pattern varies along an inner surface of at least one hollow.

13. The substrate according to claim 1, wherein at least part of the wavy and/or undulating pattern resembles sine or sinusoidal waves.

14. The substrate according to claim 1, wherein at least a part of at least one side of the extruded block is at least partially concaved or recessed.

15. The substrate according to claim 1, wherein at least one hollow is defined by a wall part, wherein the ratio of the thickness of the wall part and the height of the hollow is at least 1:3.

16. The substrate according to claim 15, wherein the wall thickness of at least one wall part is in the range of 2 to 3 centimeters.

17. The substrate according to claim 1, wherein at least part of the ceramic material is sintered incompletely.

18. A method for manufacturing a biodegradable substrate according to claim 1, comprising the steps of:
a) mixing at least one ceramic material and/or a combustible material into a malleable core material;
b) extruding the core material into an extruded block and forming at least one through-hole in the extruded block in the extrusion direction, wherein during extrusion, at least part of the surface of the extruded block is provided with a wavy and/or undulating pattern;
c) drying or solidifying the extruded block; and
d) baking the extruded block thereby burning at least part of the ceramic material and/or the combustible material of the extruded block such that a porous structure is obtained.

19. The method according to claim 18, further comprising the step of:
e) cutting the extruded block in a plurality of substrates.

20. The method according to claim 18, wherein step d) is performed at a temperature of at most 1050 degrees Celsius.

21. The method according to claim 18, further comprising the step of:
f) applying at least one biofilm to the extruded block and/or;
g) pre-charging the extruded block with oyster larvae.

22. (canceled)
